(19) United States
(12) Patent Application Publication
(10) Pub. No.: US 2016/0150016 A1
(43) Pub. Date: May 26, 2016

(54) METHOD AND DEVICE FOR COMMUNICATING VIA A SHARED INTERACTION SPACE

(71) Applicant: ORANGE, Paris (FR)

(72) Inventors: Jacques Chodorowski, Ploumillau (FR); Catherine Salou, Lannion (FR); Nadia Mer, Tregastel (FR); Mathilde Cosquer, Caouenneclanvezeac (FR); Claude Daloz, Lannion (FR)

(21) Appl. No.: 14/940,042

(22) Filed: Nov. 12, 2015

(30) Foreign Application Priority Data
Nov. 14, 2014 (FR) 1461015

(51) Int. Cl. H04L 29/08; G09G 5/00; G06F 3/0484; G09G 5/12; H04L 29/06; G06F 3/14

(52) U.S. Cl. CPC H04L 67/1097; H04L 65/403; G06F 3/1462; G06F 3/04842; G09G 5/12; G09G 5/005

(57) ABSTRACT

The invention relates to a method for communicating between at least a first terminal (T1) and a second terminal (T2). When a user of the first terminal consults at least one multimedia content via an interface associated with the first terminal, information representative of said multimedia content is stored in a first storage space of the first terminal or of a remote server. Following the establishment of the communication (E_COM) between the first terminal and the second terminal, for each multimedia content displayed on the interface associated with the first terminal, the second terminal (E10) receives information representative of the multimedia content comprised in the first storage space, and obtains (E11) said multimedia content, using said received representative information. The second terminal then modifies (E12) the display on the interface of the second terminal so as to display the multimedia content obtained and potentially a multimedia content consulted prior to establishing the communication by a user of the second terminal.

The invention relates to the field of the sharing of multimedia contents during a communication established between terminals.

A user is able to establish, via a first terminal, a telephone or videophone communication for example with a second terminal of another user. During such a communication, the users may share multimedia contents, for example images, texts, videos, photos, or other content, using the RCS (for Rich Communication Suite) communications protocol. During a communication established according to the RCS communications protocol, the user of the first terminal must select a multimedia content stored on the first terminal or on a remote device, and subsequently activate, on the first terminal, a command for the first terminal to transmit the multimedia content selected to the second terminal. In order to share a multimedia content with the second terminal, the user of the first terminal must initially establish the communication with the second terminal. A command for transmission of the multimedia content to be transmitted must subsequently be activated. Such a sharing mechanism for contents requires interactions on the first terminal, such as a search for a sharing command, selection of a sharing command or of a sharing application from amongst a plurality of possible commands, activation of the selected sharing command. Such interactions can prove to be complex to carry out when the user is already in the process of communication and can be a source of errors, for example by the selection of an incorrect sharing application.

The majority of the sharing mechanisms for multimedia contents during a communication established between terminals consist in sharing the screen of a master terminal with the other terminals of the communication. The content of the screen of the master terminal is then displayed on the screens of the other terminals involved in the communication. For example, such a mechanism is described in the document US2004/0253991A1. The drawback of such mechanisms is that only the master terminal can offer contents to be shared with the others terminals involved in the communication. For another terminal to be able to share contents during the communication, the master terminal must give the control of the communication to the other terminal.

Such a mechanism is detrimental to the interactivity and to the flexibility of the exchanges between the terminals involved in the communication.

One of the aims of the invention is to provide improvements with respect to the prior art.

For this purpose, a method is provided for creating an interaction space shared between a first terminal and a second terminal. Prior to establishing a communication between the first terminal and the second terminal,
a first storage space of a remote server is associated with a user of the first terminal, said first storage space comprising at least one piece of information representative of a first multimedia content when said user of the first terminal consults the first multimedia content over an interface associated with said first storage space and displayed on the first terminal,
a second storage space of a remote server is associated with a user of the second terminal, said second storage space comprising at least one piece of information representative of a second multimedia content, when said user of the second terminal consults the second multimedia content over an interface associated with said second storage space and displayed on the second terminal.

Following the establishment of the communication between the first terminal and the second terminal, the method for creating a shared interaction space comprises:
a step for sending to the first terminal each piece of information representative of a multimedia content comprised in the second storage space, such that the first terminal displays said multimedia content on the interface of the first terminal,
a step for sending to the second terminal each piece of information representative of a multimedia content comprised in the first storage space, such that the second terminal displays said multimedia content on the of the second terminal.

According to the invention, a user can share the multimedia contents displayed on an interface of its terminal with another user when a communication is established. Information representative of the multimedia content is stored in a storage space of a remote server. Such information representative of a multimedia content may be an address, for example a URL (for Uniform Resource Allocator), for accessing the multimedia content or the multimedia content itself.

Multimedia content is understood to mean any type of content able to be displayed or reproduced by a terminal: image, video, text, sound, Internet page, etc. Multimedia contents can be displayed in the form of thumbnails, for example when the multimedia content is an image, a video, a text or an Internet page. When the multimedia content is an audio file, the multimedia content may be displayed in the form of an audio file reader, or in a list of such a reader and reproduced by sound reproduction means of the terminal when the reader is in read mode.

When the user establishes a communication, such as a telephone or videophone communication, with another user, the method according to the invention allows a shared interaction space to be created by virtually merging the storage spaces associated with each user. Thus, each user involved in the established communication can continue to view the multimedia contents of his/her storage space and can view the multimedia contents of the storage space associated with the terminal of the other user involved in the communication. Thus, the communication established between the first terminal and the second terminal is easily enriched by the sharing of the multimedia contents. The invention is applicable to any types of communication (audio, video, text, white board drawing, etc. . . . ).

The sharing of contents between the users involved in the established communication is thus facilitated. The users do not need to activate or to select sharing commands on their terminal during the communication.

Advantageously, the storage spaces of each user are virtually merged in a temporary manner. A user only has access to the multimedia contents of the other user for the duration of the communication.

Advantageously, the storage space of each user is not physically merged within the remote server. The merging takes place in a virtual manner by sending to the first terminal the information representative of the multimedia contents of the user associated with the second storage space, allowing the first terminal to access the multimedia contents. However, such information is not stored in the first storage space. Nor is it created from common storage space comprising the information comprised in the first storage space and in the second storage space. Thus, the memory resources of the server are optimized.

The various embodiments or their features mentioned hereinafter may be added independently or in combination with one another to the steps of the method for creating a shared interaction space defined hereinabove.

According to one particular embodiment of the invention, information representative of a multimedia content comprised in the first storage space of the remote server is associated with information representative of a position on the interface associated with the first terminal, the information representative of a position corresponding to the location where the multimedia content is displayed on the interface. According to this particular embodiment of the invention, sending information representative of a multimedia content comprised in the first storage space to the second terminal furthermore comprises sending the information representative of the position of said associated multimedia content.

According to this particular embodiment of the invention, the storage space also comprises information representing the position on an interface of the terminal where the multimedia content is displayed. In this way, the first terminal or the second terminal can display on its interface a multimedia content at a position identical to that where such a content is displayed on the interface of the second terminal or of the first terminal. The users involved in the communication can then see an identical view of an interface on which the multimedia contents are displayed. Thus, the comfort of the communication and the interactivity of the communication are improved.

According to another embodiment of the invention, the method for creating a shared interaction space comprises:
a step for receiving information coming from the first terminal representative of a new multimedia content added on the interface associated with the first terminal during the established communication, following a detection of a user interaction,
a step for storing said representative information in the first storage space,
a step for sending to the second terminal said information representative of said new multimedia content such that the second terminal displays said new multimedia content on the interface associated with the second terminal.

According to this particular embodiment of the invention, when a user adds a new multimedia content on the interface of his/her terminal, the new multimedia content is also displayed on the interface of the terminal of the other user involved in the communication. Thus, the interactivity of the communication is improved.

According to one particular embodiment of the invention, when the new multimedia content is added on the interface associated with the first terminal during the established communication, the information representative of said new multimedia content is stored in the second storage space. According to this particular embodiment of the invention, when the user of the second terminal gains access later on to the second storage space, the interface associated with the second terminal will display to him/her a view of the new multimedia content. Thus, the new multimedia content is shared during the communication and information representative of this content is automatically saved in the second storage space, without requiring the intervention of the user of the second terminal.

According to another embodiment of the invention, the method for creating a shared interaction space comprises:
a step for receiving information representative of a user interaction carried out on a multimedia content displayed on the interface associated with the first terminal,
a step for sending to the second terminal information representative of said interaction received such that the second terminal reproduces the interaction carried out on the multimedia content on the interface associated with the second terminal.

According to this particular embodiment of the invention, a user interaction carried out on a multimedia content displayed on the interface associated with the first terminal is reproduced on the interface associated with the second terminal. Thus, the interactivity of the communication is improved.

According to this particular embodiment of the invention, a user interaction can correspond to the displacement on the interface of the multimedia content, to an enlargement or a reduction of the size of a window in which the multimedia content is displayed, to a text or drawing composition, to a selection or activation of a button or a hypertext link to an Internet page, etc.

The invention also relates to a method for communicating between at least a first terminal and a second terminal. Prior to establishing a communication between the first terminal and the second terminal:
a first storage space from the first terminal or from a remote server is associated to a user of the first terminal, when said user of the first terminal consults at least one multimedia content via an interface associated with the first storage space and displayed on the first terminal, one piece of information representative of said multimedia content is stored in said first storage space,
a second storage space from the second terminal or from a remote server is associated to a user of the second terminal, when a user of the second terminal consults at least one multimedia content via an interface associated with the second storage space and displayed on the second terminal, one piece of information representative of said multimedia content is stored in said second storage space.

The method of communication comprises:
following a step for establishing the communication between the first terminal and the second terminal, the following steps:
   for each multimedia content displayed on the interface of the first terminal:
      the second terminal receives piece of the information representative of the multimedia content comprised in the first storage space,
      the second terminal obtains the multimedia content corresponding to piece of information received, using said received piece of representative information,
      the display on the interface of the second terminal is modified so as to display the multimedia content consulted prior to establishing the communication and the multimedia content obtained.

The method of communication according to the invention thus allows multimedia contents to be easily shared during a communication established between a first terminal and a second terminal. According to the method of communication of the invention, as soon as the communication between the first terminal and the second terminal has been established, the first terminal displays to a user both the multimedia contents initially displayed on the interface of the first terminal and the multimedia contents displayed on the interface of the second terminal. The view of the interface of the first terminal and the view of the interface of the second terminal are thus temporarily merged in order to create a shared interaction space. Such a merging is established for the duration of the communication between the first terminal and the second terminal.

Advantageously, the information representative of the second multimedia content may be received coming from the second terminal or from a remote server.

The various embodiments or their features mentioned hereinafter may be added independently or in combination with one another, aux steps of the method of communication defined hereinabove.

According to one particular embodiment of the invention, the method of communication furthermore comprises, for each piece of information representative of a multimedia content comprised in the second storage space, a step for sending to the first terminal said representative information.

According to this particular embodiment of the invention, the first terminal can thus display on the interface associated with the first terminal the multimedia content consulted by the user of the first terminal via the interface associated with the first terminal prior to establishing the communication and the multimedia content obtained from the representative information comprised in the second storage space and sent to the first terminal.

According to another embodiment of the invention, the method of communication furthermore comprises a step where the second terminal receives information representative of a position for displaying a multimedia content on the interface associated with the first terminal, such that the multimedia content is displayed on the interface associated with the second terminal at a position identical to said display position on the interface associated with the first terminal.

According to another embodiment of the invention, the addition of a new multimedia content on the interface associated with the first terminal during the established communication triggers:
a step where the second terminal receives information representative of said new multimedia content,
a step where the second terminal obtains the new multimedia content using said received representative information so as to display the new multimedia content on the interface associated with the second terminal.

According to another embodiment of the invention, the end of the communication established between the first terminal and the second terminal triggers:
a step for modification of the interface associated with the first terminal so as to display only the multimedia contents for which representative information is stored in the first storage space,
a step for modification of the interface associated with the second terminal so as to display only the multimedia contents for which representative information is stored in the second storage space.

According to this particular embodiment of the invention, the sharing of the multimedia contents between the user of the first terminal and the user of the second terminal takes place in a temporary manner for the duration of the communication. At the end of the communication, each user only conserves on his/her interface the multimedia contents which were initially displayed prior to establishing the communication and, where relevant, the multimedia contents added during the course of the communication. At the end of the communication, each user only conserves on his/her interface the multimedia contents for which representative information is stored in the storage space associated with the corresponding user. Thus, the memory resources of the terminals are optimized.

In addition, this particular embodiment of the invention allows of assurer a certain protection of the multimedia contents by only making it available to another user for the duration of the communication.

According to another embodiment of the invention, the method of communication comprises a step for storing in a memory space associated with the second terminal a content displayed on the interface associated with the first terminal and for which representative information is stored in the first storage space, following the detection of a user interaction intended to select said content in order to store it permanently in a memory space associated with the second terminal. According to this particular embodiment of the invention, a user can select a multimedia content in order to record it in a memory of his/her terminal. As a variant, the authorization of the other user may be necessary in order to allow the user to record such a multimedia content.

According to another embodiment of the invention, following a step for detecting an interaction carried out on a multimedia content displayed on the interface of the first terminal, the method comprises:
a step where the second terminal receives information representative of said interaction,
a step for modification of the display of the multimedia content on the interface of the second terminal so as to reproduce said interaction on said interface.

According to this particular embodiment of the invention, the users can communicate via the interface of the first terminal and the interface of the second terminal to the means for interactions carried out on the multimedia contents displayed on such interfaces in addition to the telephone or videophone communication established between the first terminal and the second terminal.

According to another embodiment of the invention, when the established communication is a videophone communication:
a multimedia content corresponding to the video generated and transmitted by the first terminal is displayed on the interface associated with the second terminal,
and/or a multimedia content corresponding to the video generated and transmitted by the second terminal is displayed on the interface associated with the first terminal.

According to this particular embodiment of the invention, the video component of the established communication is a multimedia content displayed on the interface of each terminal. This particular embodiment of the invention allows the visual data of the videophone communication, such as the video stream, to be integrated into the interaction space shared by the terminals T1 and T2. The communication between the terminals T1 and T2 is thus easier for the users of the terminals T1 and T2 because it is not necessary to have on the display device of the terminal T1 or T2 separate windows for the video data of the communication and for the shared interaction space.

The invention also relates to a server for creating a shared interaction space, comprising:
a storage module designed to store:
   in a first storage space associated with a user of the first terminal, at least one piece of information representative of a multimedia content, when said user of the first terminal consults said multimedia content on an interface associated with said first storage space and displayed on the first terminal,
   in a second storage space associated with a user of the second terminal, at least one piece of information representative of a multimedia content when said user of the second terminal consults said multimedia content on an interface associated with said second storage space and displayed on the second terminal,
a processing module designed to detect the establishment of the communication between the first terminal and the second terminal,
a communication module activated on a command from the processing module following the establishment of the communication between the first terminal and the second terminal, said communication module being designed to send:
   to the first terminal, each piece of information representative of a multimedia content comprised in the second storage space, such that the first terminal displays said multimedia content on the interface of the first terminal,
   to the second terminal, each piece of information representative of a multimedia content comprised in the first storage space, such that the second terminal displays said multimedia content on the interface of the second terminal.

The invention also relates to a communication terminal comprising:
an interface suitable for displaying, prior to establishing a communication between the terminal and another terminal, at least one first multimedia content consulted by a user of the terminal, one piece of information representative of the first multimedia content consulted being stored in a first storage space associated with the user of the terminal when said user consults said first multimedia content via said interface,
a processing module designed to establish a communication with said other terminal, a user of said other terminal being associated with a second storage space comprising at least one piece of information representative of a second multimedia content when the user of the other terminal consults said multimedia content via an interface displayed on the other terminal,
a communication module designed to:
   receive each piece of information representative of a multimedia content comprised in the second storage space,
   obtain, from received piece of representative information, a multimedia content corresponding to the received piece of information,
the processing module being capable of modifying the display on the interface of the terminal so as to display the first multimedia content consulted prior to establishing the communication and the multimedia content obtained.

In one particular embodiment of the invention, the various steps of the method of communication and of the method for creating a shared interaction space are implemented by computer program instructions.

Consequently, the invention is also aimed at computer programs on an information medium, these programs being able to be respectively implemented in a terminal or, more generally, in a computer, these programs respectively comprising instructions intended for the implementation of the various steps of the method of communication and of the various steps of the method for creating a shared interaction space which have just been described.

These programs may use any given programming language, and be in the form of source code, object code, or of code intermediate between source code and object code, such as in a partially compiled form, or in any other desirable form.

The invention is also aimed at an information medium readable by a computer, and comprising instructions of a computer program such as mentioned hereinabove.

The information medium may be any given entity or device capable of storing the program. For example, the medium may comprise a storage means, such as a ROM, for example a CD ROM or a microelectronic circuit ROM, or also a magnetic or electronic means of recording, for example a USB key or a hard disk.

On the other hand, the information medium may be a transmissible medium such as an electrical or optical signal, qui can be conveyed via an electrical or optical cable, by radio or by other means. The program according to the invention may in particular be downloaded over a network of the Internet type.

Alternatively, the information medium may be an integrated circuit into which the program is incorporated, the circuit being designed to execute or to be used in executing the method of communication or of the method for creating a shared interaction space en question.

The advantages of the server, of the communication terminal, of the computer program comprising instructions intended for the implementation of the various steps of the method of communication and of the computer program comprising instructions intended for the implementation of the various steps of the method for creating a shared interaction space are identical to those presented in relation to the method of communication and to those presented in relation to the method for creating a shared interaction space according to any one of the particular embodiments mentioned hereinabove.

### LIST OF THE FIGURES

Other advantages and features of the invention will become more clearly apparent upon reading the following description of a particular embodiment of the invention, presented by way of a simple illustrative and non-limiting example, and of the appended drawings, amongst which:

FIG. 1 illustrates one environment for implementation of the invention according to one particular embodiment of the invention,

FIG. 2 illustrates schematically steps of the method for creating a shared interaction space and steps of the method of communication according to one particular embodiment of the invention,

FIGS. 3A, 3B, 3C, 3D and 3E illustrate schematically an interface of a first terminal implementing the method of communication according to one particular embodiment of the invention,

FIGS. 4A, 4B, 4C, 4D and 4E illustrate schematically an interface of a second terminal implementing the method of communication according to one particular embodiment of the invention,

FIG. 5 illustrates a server capable of implementing the method for creating a shared interaction space according to one particular embodiment of the invention.

FIG. 6 illustrates a terminal capable of implementing the method of communication according to one particular embodiment of the invention.

### DESCRIPTION OF ONE PARTICULAR EMBODIMENT OF THE INVENTION

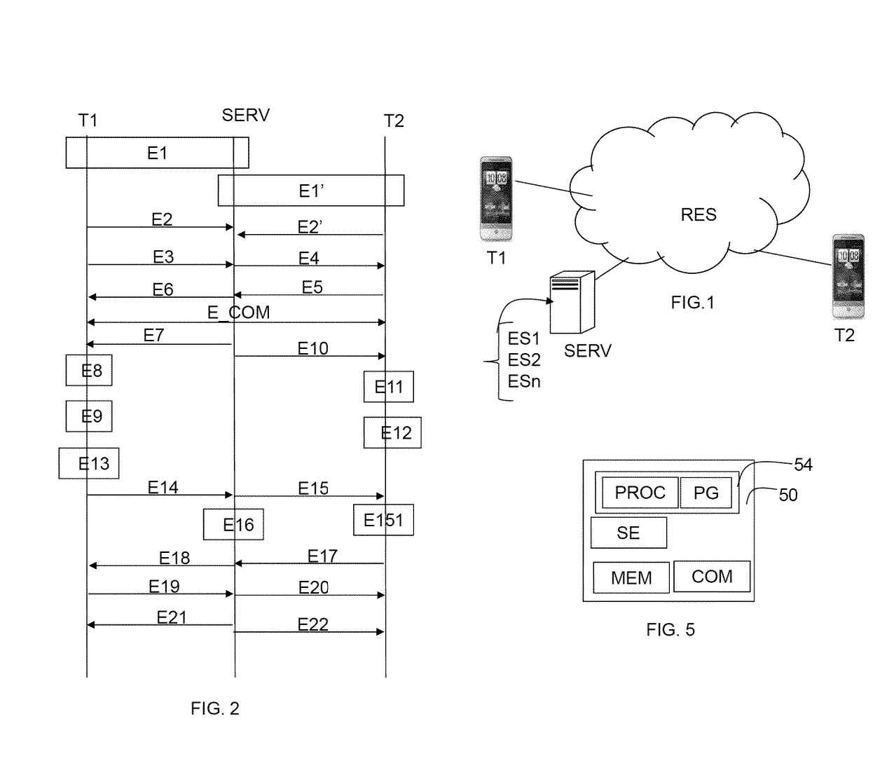

The FIG. 1 illustrates an environment for implementation of the invention according to one particular embodiment of the invention. The environment described en FIG. 1 comprises a communications network RES allowing data to be exchanged and communications to be established between terminals connected to the communications network RES. For example, the communications network RES is a mobile IP communications networks of the 4G type or a fixed IP communications network. The communications network RES is for example a communications network IP based on an IMS (for IP Multimedia Subsystem) architecture.

The communications network RES may also be a group of communications networks mutually interconnected via interconnection servers (not shown). The environment in FIG. 1 also comprises terminals T1 and T2 connected to the communications network RES.

The terminals T1 and T2 may be any type of terminals allowing a telephone or videophone communication to be established, such as a mobile telephone, a smartphone, a tablet, a television connected to a communications network, a personal computer on which a telephony application, also known as ‘softphone’, is installed.

More particularly, the terminals T1 and T2 are capable of communicating via the communications network RES during a communication established in audio or videophone mode, or during a communication established in text or drawing mode such as during an instant messaging session. The terminals T1 and T2 are capable of displaying, on an interface associated with the terminal T1 or T2, multimedia contents with a view to their consultation.

According to one particular embodiment of the invention, the terminal T1 and the terminal T2 are capable of establishing a communication according to the WebRTC technology. Such a WebRTC technology enables communications between the terminal T1 and the terminal T2 to be established over a communications network IP, for example the communications network RES, via the Internet browser of each terminal.

According to this particular embodiment of the invention, the environment in FIG. 1 comprises an application server SERV managing the signaling of a communication to be established between the terminals T1 and T2. The application server SERV registers the terminals T1 and T2 when the latter indicate to the application server SERV that they are available for communicating according to the WebRTC protocol. The application server SERV holds a first communication channel open with the terminal T1 and a second communication channel open with the terminal T2. Such communication channels allow the application server SERV to receive a communication request coming from the terminal T1 or from the terminal T2 destined for another terminal or to inform the terminal T1 or the terminal T2 that a communication request has been sent to it. When a communication is established between the terminals T1 and T2, the data stream for the communication does not transit via the application server SERV, but goes directly in point-to-point mode between the terminals T1 and T2, via the communications network RES.

According to another embodiment of the invention, the terminal T1 and the terminal T2 are capable of establishing a communication according to the protocol SIP (for Session Initiation Protocol).

According to this other particular embodiment of the invention, the signaling of a communication to be established between the terminals T1 and T2 is managed by application servers of the IMS core of the communications network RES. In order to receive or transmit a communication, the terminal T1, respectively T2, registers with the core of the communications network RES by sending an SIP message REGISTER. The establishing of a communication between the terminal T1 and the terminal T2 is achieved by the exchange of SIP messages (INVITE, 180 Ringing, 200OK, ACK) between the terminals T1 and T2, via the core of the communications network RES. When a communication has been established between the terminals T1 and T2, the data stream for the communication goes directly in point-to-point mode between the terminals T1 and T2, via the communications network RES.

According to one particular embodiment of the invention, the server SERV is a remote server implementing the method for creating a shared interaction space. For this purpose, the server SERV comprises a storage space assembly ES1, ES2, ESn respectively associated with a user having previously configured an account with the service provider managing the server SERV. These storage spaces are intended to comprise at least one piece of information representative of a multimedia content belonging to the user associated with the corresponding storage space. This information representative of a multimedia content may correspond to an address, for example a URL, allowing the multimedia content to be accessed. The information representative of a multimedia content may also correspond to a file comprising the multimedia content in a standard coded form. Thus, the multimedia content may be stored on the remote server SERV or on another server (not shown), or again on a terminal of the user associated with the storage space comprising the information representative of the multimedia content.

When a user of a terminal gains access to the storage space associated with him/her and configured within the server SERV, an interface of the terminal displays a view of the multimedia contents to the user, representative information of which is comprised in the storage space.

For example, following the configuration of the storage space associated with the user of the terminal, an icon allowing the direct access to the storage space is displayed on a screen of the terminal. When the user clicks this icon, the terminal gains access to the storage space associated with the user of the terminal. The terminal then displays an interface comprising a representation of each multimedia content for which representative information is comprised in the storage space associated with the user of the terminal. Thus, the access to the storage space allows the user to consult the multimedia contents for which representative information is comprised in the storage space.

When a user consults a new multimedia content via the interface of the terminal dedicated to the storage space, information representative of the multimedia content is sent to the server SERV and stored in the storage space associated with the user of the terminal. The user can consult a multimedia content via such an interface by dragging a multimedia content into the interface or by opening a multimedia content via a menu of the interface.

Thus, the storage space comprises information representative of contents in the process of being consulted by the user via the dedicated interface of his/her terminal. If the user deletes a multimedia content from this interface, a delete command is sent to the server SERV such that the server SERV deletes fromx the storage space the information representative of this multimedia content.

According to one particular embodiment of the invention, the information representative of a multimedia content is associated with information representative of a location of the multimedia content on the interface. According to this particular embodiment of the invention, the storage space stores in memory, for each multimedia content, the location where a representation of the multimedia content is displayed on the interface of the terminal. When the user of the terminal carries out an interaction on his/her terminal for displacing a multimedia content displayed on the interface, the terminal sends a command to the server SERV such that the information representative of the location of the multimedia content on the interface stored by the server SERV is updated based on the new position of the multimedia content on the interface.

This particular embodiment of the invention allows that, when the user accesses the storage space at a later time, the interface of his/her terminal displays a representation of the multimedia contents comprised in the storage space such as it was when the storage space was last consulted by the user.

The communication between the terminal of the user and the server SERV may for example be carried out via HTTP requests.

According to one particular embodiment of the invention, the storage space can be configured locally on the terminal of the user, such that the use of the remote server SERV is redundant.

According to any one of the embodiments of the invention, using or not using the server SERV, the user of the terminal T1 has configured a storage space ES1. The user of the terminal T2 could also have configured a storage space ES2.

According to the method of communication according to the invention, when the user of the terminal T1 gains access to the storage space ES1 and when he/she establishes a communication with the user of the terminal T2, a shared interaction space is created such that the terminal T2 gains access to the storage space ES1 and that the terminal T1 gains access to the storage space ES2.

FIG. 2 illustrates schematically steps of the method for creating a shared interaction space and steps of the method of communication according to one particular embodiment of the invention.

According to this particular embodiment of the invention, the method for creating a shared interaction space is implemented by a remote server, for example the server SERV in FIG. 1. The method of communication is implemented by the terminals T1 and T2 in FIG. 1.

During an initialization step E1, the terminal T1 configures a storage space ES1 associated with the user of the terminal T1 within the server SERV. For example, the user of the terminal T1 sends a request to the server SERV to create a user account supplying a user name and a password. Such a configuration can be set up via a web application or an Internet page supplied by a service provider managing the server SERV. During the step E1, the server SERV creates a storage space ES1 associated with the user of the terminal T1.

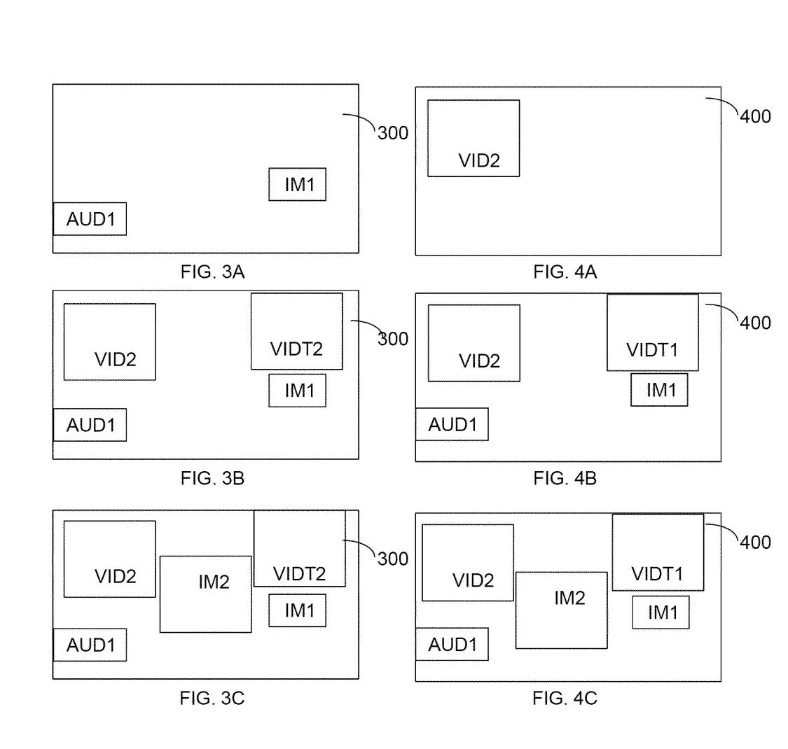

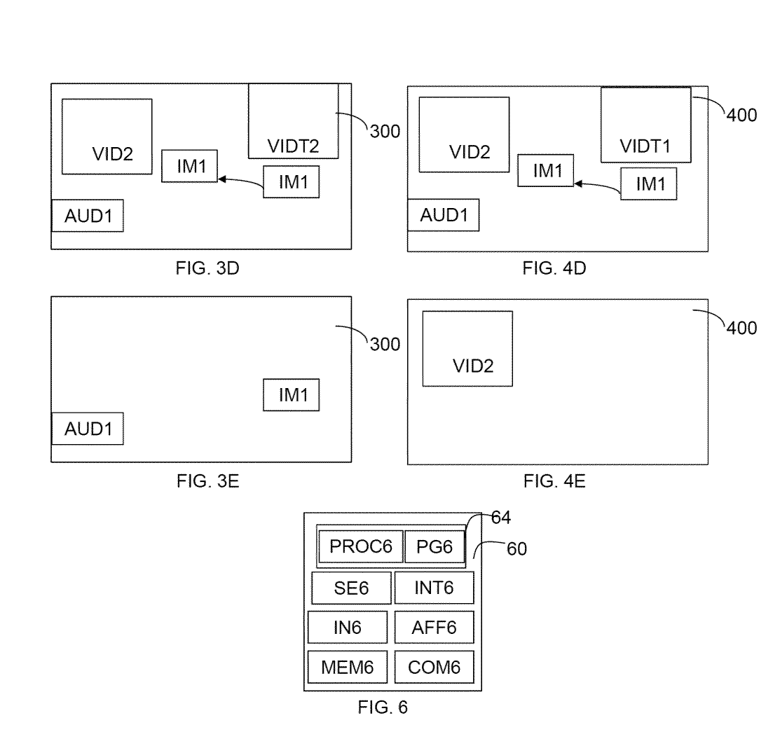

During a step E2, the user of the terminal T1 adds multimedia contents to the storage space ES1, for example an image IM1 and an audio file AUD1, via an interface of the terminal T1 dedicated to the display of the storage space ES1. Such an interface is for example illustrated by FIG. 3A. FIG. 3A represents an interface 300 of the terminal T1 comprising a representation of the image IM1, displayed for example in the form of a thumbnail, and of the audio file AUD1, displayed in the form of an audio file reader.

During the step E2, the terminal T1 sends to the server SERV:
information representative of the multimedia content IM1, together with information representative of the location of IM1 on the interface 300,
information representative of the multimedia content AUD1, together with information representative of the location of AUD1 on the interface 300,

This information is stored by the server SERV in the storage space ES1.

The information representative of a location of a multimedia content may for example comprise:
the position of the center of the thumbnail representing the multimedia content,
an angle of rotation of the thumbnail with respect to a vertical or horizontal axis,
a display scale for the thumbnail.

In a similar manner to the step E1, during a step E1′, the terminal T2 configures a storage space ES2 associated with the user of the terminal T2 within the server SERV.

During a step E2′, the user of the terminal T2 adds a multimedia content to the storage space ES2, for example a video VID2, via an interface of the terminal T2 dedicated to the display of the storage space ES2. Such an interface is for example illustrated by FIG. 4A. FIG. 4A shows an interface 400 of the terminal T2 comprising a representation of the video VID2, displayed for example in the form of a thumbnail.

During a step E3, the user of the terminal T1 wishes to communicate with the user of the terminal T2. To this end, during the step E3, the user activates a communication request command via the interface of the terminal T1 dedicated to the display of the storage space ES1 and selects the identity of the user of the terminal T2. For example, the user of the terminal T1 requests a videophone communication. During the step E3, the terminal T1 sends, to the server SERV, a communication request intended for the user of the terminal T2. Such a communication request notably comprises the information allowing the terminal T2 to receive an audio stream and a video stream of the communication coming from the terminal T1. This information corresponds for example to the IP address and to the communication ports used by the terminal T1. The communication request is received by the server SERV during the step E3.

During a step E4, the server SERV transmits the communication request received during the step E3 to the terminal T2.

After the communication request has been received by the terminal T2 during the step E4, the terminal T2 triggers a presentation of the communication request so as to informer the user of the terminal T2 of the communication request received. For example, the terminal T2 displays on the interface 400 of the terminal T2 a message indicating the reception of a communication request coming from the user of the terminal T1, together with buttons allowing the communication request to be accepted or declined. During the step E4, the user of the terminal T2 accepts the communication request.

Following the acceptance of the communication request by the user of the terminal T2, during a step E5, the terminal T2 sends to the server SERV a message of acceptance for the communication request. The acceptance message notably comprises the information allowing the terminal T1 to receive an audio stream and a video stream of the communication coming from the terminal T2. Such information corresponds for example to the IP address and to the communication ports used by the terminal T2.

During a step E6, the server SERV transmits the message for acceptance of the communication request to the terminal T1.

During a step E_COM, the videophone communication is established between the terminals T1 and T2 thanks to the communication information respectively transmitted by the terminal T1 to the terminal T2 in the communication request generated during the step E3 and by the terminal T2 to the terminal T1 in the acceptance message generated during the step E5. The steps E3 to E6 are for example implemented according to the WebRTC communications protocol.

A multimedia content VIDT2 relating to the video part of the videophone communication transmitted by the terminal T2 is then displayed by the terminal T1 on the interface 300, as illustrated in FIG. 3B.

A multimedia content VIDT1 relating to the video part of the videophone communication transmitted by the terminal T1 is then displayed by the terminal T2 on the interface 400, such as illustrated in FIG. 4B.

The audio and video data streams of the communication are transmitted during the step E_COM between the terminals T1 and T2 via the communications network RES.

Following the acceptance of the communication request received during the step E5, during a step E7 and a step E10, the server SERV will create an interaction space shared between the terminals T1 and T2.

For this purpose, during the step E7, the server SERV sends to the terminal T1, for each multimedia content displayed on the interface 400 of the terminal T2, the information representative of the multimedia content stored in the storage space ES2 associated with the user of the terminal T2, together with the information representative of the position of the multimedia content on the interface 400.

During the step E10, the server SERV sends to the terminal T2, for each multimedia content displayed on the interface 300 of the terminal T1, the information representative of the multimedia content stored in the storage space ES1 associated with the user of the terminal T1, together with the information representative of the position of the multimedia content on the interface 300.

Following the reception during the step E7, by the terminal T1, of at least one piece of information representative of a multimedia content, the terminal T1 obtains, during a step E8, each multimedia content from the corresponding representative information received. For example, using received representative information, the terminal T1 gains access to a remote server or to the terminal T2 on which the corresponding multimedia content is stored in memory and downloads it into a temporary memory.

During a step E9, the terminal T1 displays the multimedia contents obtained during the step E8 on the interface 300. According to one particular embodiment of the invention, the multimedia contents obtained are displayed on the interface 300 at positions identical to the positions where they are displayed on the interface 400 of the terminal T2.

The interface 300 of the terminal T1 following the step E9 is for example illustrated by the FIG. 3B. FIG. 3B comprises:
a representation of the multimedia contents IM1, AUD1, of the storage space ES1,
a representation of the multimedia contents obtained during the step E8:VID2.

Following the reception, during the step E10, by the terminal T2, of at least one piece of information representative of a multimedia content, the terminal T2 obtains, during a step E11, each multimedia content from the corresponding representative information received. For example, using received representative information, the terminal T2 gains access to a remote server or to the terminal T1 on which the corresponding multimedia content is stored in memory and downloads it into a temporary memory.

During a step E12, the terminal T2 displays the multimedia contents obtained during the step E11 on the interface 400. According to one particular embodiment of the invention, the multimedia contents obtained are displayed on the interface 400 at positions identical to the positions where they are displayed on the interface 300 of the terminal T1.

The interface 400 of the terminal T2 following the step E11 is for example illustrated by FIG. 4B. FIG. 4B comprises:
a representation of the multimedia contents VID2 comprised in the storage space ES2,
a representation of the multimedia contents obtained during the step E11: IM1, AUD1.

Thus, the users of the terminals T1 and T2 dispose of the same representation of their multimedia content and can communicate over such contents during the communication established during the step E_COM.

According to the invention, a shared interaction space has thus been created between the terminals T1 and T2 starting from the storage spaces ES1 and ES2 respectively associated with the users of the terminals T1 and T2. Such a shared interaction space is represented on the terminal T1 by the display interface 300 and on the terminal T2 by the display interface 400. The interaction space is shared in the sense that each user of the terminal T1 or of the terminal T2 gains access to the multimedia contents of his/her storage space and to the multimedia contents of the storage space of the other user with whom he/she is in communication. The creation of the shared interaction space is temporary and only lasts for the duration of the communication. The shared interaction space is interactive in the sense that each user can, via the interface of his/her terminal, interact on the multimedia contents displayed, add other contents or remove those of his/her storage space.

According to a first example, the user of the terminal T1 wishes to add a new multimedia content to the interaction space shared between the terminals T1 and T2 during the communication.

During a step E13, the terminal T1 detects a user interaction adding to the interface 300 of the terminal T1 a new multimedia content, for example an image IM2. During the step E13, the terminal T1 modifies the display of the interface 300 so as to display the new multimedia content IM2 on the interface 300, such as illustrated by FIG. 3C.

Following the step E13, during a step E14, the terminal T1 sends, to the server SERV, information representative of the multimedia content IM2 and information representative of the position of IM2 on the interface 300.

During the step E14, the server SERV determines that the data of the storage space ES1 associated with the user of the terminal T1 needs to be updated. For this purpose, during a step E16, the server SERV stores in the storage space ES1, associated with the user of the terminal T1, the information representative of the multimedia content IM2 and the information representative of the position of IM2 on the interface 300 received during the step E14.

Then, during a step E15, the server SERV sends to the terminal T2 the information representative of the multimedia content IM2 and the information representative of the position of IM2 on the interface 300 such that the terminal T2 updates the interface 400.

During the step E15, the terminal T2 receives the information representative of the multimedia content IM2 and the information representative of the position of IM2 on the interface 300.

During a step E151, the terminal T2 obtains the multimedia content IM2 using the information representative of the multimedia content IM2 and modifies the interface 400 so as to display the multimedia content IM2.

During the step E151, the terminal T2 displays on the interface 400 the multimedia content IM2 by using the information representative of the position of IM2 on the interface 300 received. Following the step E151, the interface 400 is modified such as illustrated by FIG. 4C.

According to one particular embodiment of the invention, during the step E16, the server SERV also stores in the storage space ES2 associated with the user of the terminal T2, the information representative of the multimedia content IM2.

According to a second example, the user of the terminal T1 displaces, on the interface 300, a multimedia content of the interaction space shared between the terminals T1 and T2. During the step E13, the terminal T1 detects a user interaction displacing the multimedia content IM1 on the interface 300 of the terminal T1. The display of the interface 300 is modified so as to display the multimedia content IM1 at its new position such as illustrated by FIG. 3D.

Following the step E13, during a step E14, the terminal T1 sends, to the server SERV, information representative of the new position of IM1 on the interface 300.

During the step E14, since the multimedia content IM1 belongs to the storage space ES1, the server SERV determines that the data of the storage space ES1 associated with the user of the terminal T1 needs to be updated. For this purpose, during a step E16, the server SERV updates, in the storage space ES1 associated with the user of the terminal T1, the information representative of the position of IM1 based on the information representative of the new position of IM1 received during the step E14.

Then, during a step E15, the server SERV sends to the terminal T2 the information representative of the new position of IM1 on the interface 300 such that the terminal T2 updates the interface 400.

During the step E15, the terminal T2 receives the information representative of the new position of IM1 on the interface 300.

During a step E151, the terminal T2 modifies the interface 400 so as to reproduce the displacement of the multimedia content IM1 on the interface 400 and display it at the new position. The modification of the interface 400 is illustrated by FIG. 4D.

According to another example, the user of the terminal T1 can interact on a multimedia content of the storage space ES2. In this case, the data relating to this multimedia content in the storage space ES2 are updated by the server SERV depending on this interaction and transmitted to the terminal T2 for the terminal T2 to update the interface 400.

According to another example, the user interaction of the user of the terminal T1 may be an enlargement or a reduction of the thumbnail representing a multimedia content. The parameters of such a transformation are then transmitted to the server SERV which updates the data associated with the multimedia content in the storage space to which the multimedia content belongs. The modification of the data is also transmitted to the terminal T2 for the terminal T2 to reproduce the transformation on the interface 400.

According to another embodiment of the invention, the user of the terminal T1 and the user of the terminal T2 may interact remotely simultaneously on the same multimedia content. This particular embodiment of the invention is particularly advantageous when the multimedia content is a window of an Internet browser, a game or a collaborative drawing.

According to this particular embodiment, the interaction of the user of the terminal T1 on the multimedia content displayed on the interface 300, for example the activation of a hypertext link on an Internet page or the composition of a drawing, is transmitted to the server SERV which transmits a command to the terminal T2 enabling the terminal T2 to reproduce the interaction of the user of the terminal T1.

According to the method of communication according to the invention, only the interactions carried outs on the multimedia contents displayed in the shared interaction space are transmitted between the terminals T1 and T2 so as to be reproduced on each terminal involved in the communication.

For example, a user interaction relating to the opening of a menu on the interface 300 of the terminal T1 in order to select a new multimedia content for adding it to the shared interaction space is not transmitted to the terminal T2. Such an interaction does not need to be reproduced on the terminal T2. Only the addition of the new content must be reproduced by displaying the new content selected.

During a step E17, the user of the terminal T2 wishes to terminate the communication established between the terminal T1 and the terminal T2. For this purpose, the terminal T2 detects a user interaction on the interface 400 indicating the end of the videophone communication. During the step E17, the terminal T2 then sends to the server SERV a message indicating the end of the communication with the terminal T1. During the step E17, the terminal T2 modifies the interface 400 so as to delete the display VIDT1 of the video of the communication generated by the terminal T1.

During a step E18, the server SERV transmits such a message to the terminal T1 which acknowledges it by sending an acknowledgement message to the server SERV during a step E19. The server SERV transmits the acknowledgement message to the terminal T2 during a step E20. During the step E19, the terminal T1 modifies the interface 300 so as to delete the display VIDT2 of the video of the communication generated by the terminal T2.

The end of the communication between the terminals T1 and T2 is for example implemented during the steps E17 to E20 according to the WebRTC protocol.

Following the end of the communication between the terminal T1 and the terminal T2, during a step E22, the server SERV sends a command to the terminal T2 for modification of the interface 400 to delete from the interface 400 the representation of the multimedia contents of the storage space ES1. The interface 400 of the terminal T2 then only comprises the multimedia contents comprised in the storage space ES2, such as illustrated by FIG. 4E.

Following the end of the communication between the terminal T1 and the terminal T2, the server SERV also sends to the terminal T1, during a step E21, a command for modification of the interface 300 to delete from the interface 300 the representation of the multimedia contents of the storage space ES2. The interface 300 of the terminal T1 then only comprises the multimedia contents comprised in the storage space ES1, such as ‘illustrated by FIG. 3E.

According to another embodiment of the invention, during the communication established between the terminal T1 and the terminal T2, the user of the terminal T1 or of the terminal T2 can request the permanent recording of a multimedia content of the shared interaction space. For this purpose, the terminal T1 detects a user interaction opening a menu relating to a multimedia content, for example the multimedia content VID2, and selecting a command for local recording of the multimedia content. The terminal T1 then stores in a permanent memory space the multimedia content VID2. Such a recording allows the user of the terminal T1 to access the multimedia content VID2 even when the communication with the terminal T2 has ended. The interaction of opening the menu and of selection of the action is not reproduced on the terminal T2. However, as a variant, the recording by the terminal T1 of the multimedia content VID2 may be conditioned by an authorization of the user of the terminal T2. Prior to the recording, the terminal T1 then sends a request for authorization to record the multimedia content VID2 to the terminal T2. The terminal T2 can display an authorization request message on the interface 400. If the user of the terminal T2 accepts such a recording, the terminal T2 sends an authorization message to the terminal T1 and the terminal T1 records the multimedia content in a permanent memory space.

As a variant, instead of recording the multimedia content VID2 in a permanent memory space, the recording command corresponds to an addition of information representative of the multimedia content VID2 in the storage space ES1 of the user of the terminal T1.

According to another embodiment of the invention, the method for creating a shared interaction space is implemented by the terminals T1 and T2, without the server SERV. In this particular embodiment of the invention, the storage spaces ES1 and ES2 associated with each user are respectively created on the terminals T1 and T2. When the communication between the terminals T1 and T2 is established, the information representative of the multimedia contents comprised in the storage spaces ES1 and ES2 and the information representative of the display locations of these multimedia contents are directly transmitted by the terminal T1 or the terminal T2 to the other terminal T2 or T1. The terminal T1 and the terminal T2 stores in memory, for each multimedia content displayed on the interface 300 or 400, whether the multimedia content belongs to the storage space ES1 or ES2, such that the merging of the storage spaces remains virtual on the interface 300 and the interface 400. Thus, at the end of the communication between the terminal T1 and the terminal T2, the terminal T1, respectively T2, can delete, on the interface 300, respectively 400, the display of the multimedia contents which do not belong to the storage space ES1, respectively ES2, associated with the user of the terminal T1, respectively T2.

According to this particular embodiment of the invention, the establishing of the communication may for example be implemented according to the SIP protocol. The transmission of the information representative of the multimedia contents and of their information representative of their display location can be transmitted in SIP messages dedicated to the invention.

The method for creating a shared interaction space and the method of communication via said shared interaction space can be implemented when more than two terminals are involved in the established communication.

FIG. 5 illustrates a server capable of implementing the method for creating a shared interaction space according to one particular embodiment of the invention described with reference to FIG. 2.

The server 50 comprises a processing module 54, notably comprising a storage module MEM, for example a memory, and a processing unit PROC, equipped for example with a microprocessor. The processing unit PROC is controlled by a computer program PG implementing the method for creating a shared interaction space such as described with reference to FIG. 2.

The storage module MEM is configured for associating a storage space of the storage module MEM with a user of a terminal, for example the terminal T1 or T2 in FIG. 1. Such a storage space is able to comprise at least one piece of information representative of a multimedia content displayed on an interface of the terminal.

Upon initialization, the code instructions of the computer program PG are for example loaded into memory MEM before being executed by the processor of the processing unit PROC.

The processor of the processing unit PROC implements the steps of the method for creating a shared interaction space using at least a first storage space associated with a user of a first terminal and at least a second storage space associated with a user of a second terminal, according to the instructions of the computer program PG. The processor of the processing unit PROC notably implements:
for each piece of information representative of a multimedia content comprised in the second storage space, a step for sending said information representative of said multimedia content to the first terminal, such that the first terminal displays said multimedia content on a first interface associated with the first terminal,
for each piece of information representative of a multimedia content comprised in the first storage space, a step for sending said information representative of said multimedia content to the second terminal, such that the second terminal displays said multimedia content on a second interface associated with the second terminal.

The server 50 also comprises a communication module COM allowing the server 50 to connect to a communications network and to exchange data with the terminals T1 and T2 connected to this communications network. The communication module COM is designed to send information representative of a multimedia content comprised in a storage space of the storage module to a terminal and to receive such information coming from another terminal.

FIG. 6 illustrates a terminal capable of implementing the method of communication according to one particular embodiment of the invention, for example such as described with reference to FIG. 2.

The terminal 60 comprises a processing module 64, notably comprising a storage module MEM6, for example a memory, and a processing unit PROC6, equipped for example with a microprocessor. The processing unit PROC6 is controlled by a computer program PG6 implementing the method of communication such as described with reference to FIG. 2.

Upon initialization, the code instructions of the computer program PG6 are for example loaded into memory MEM6 prior to being executed by the processor of the processing unit PROC6.

The processor of the processing unit PROC6 implements the steps of the method for communicating between at least the terminal 60 and a second terminal, according to the instructions of the computer program PG6.

The terminal 60 comprises an interface INT6 capable of displaying at least a first multimedia content using information representative of said multimedia content comprised in a storage space ES1. The interface INT6 is for example a graphical interface associated with the computer program PG6.

The processor of the processing unit PROC6 notably implements:
a step for establishing the communication between the first terminal and the second terminal,
when a storage space ES2 associated with a user of the second terminal comprises at least one piece of information representative of a multimedia content, for each piece of information representative of a multimedia content comprised in the storage space ES2:
   the terminal 60 receives said information representative of a multimedia content,
   the terminal 60 obtains said multimedia content, using said received representative information,
   the display on the interface INT6 is modified so as to display said multimedia content obtained and the at least a first multimedia content, for the duration of the communication established between the terminal 60 and the second terminal.

The storage module MEM6 is designed to store temporarily, for the duration of the communication established between the terminal 60 and the second terminal, said multimedia content with a view to its display by the interface INT6.

The terminal 60 also comprises a display device AFF6, such as a screen integrated into the terminal 60 or connected to the terminal 60.

The display on the display device AFF6 is controlled by the processor of the processing unit PROC6 according to the code instructions of the computer program PG6 and of the operating system SE6 of the terminal 60.

The terminal 60 comprises a user interaction module IN6 allowing a user to interact on the terminal 60. The user interaction module IN6 notably allows a user to interact on a multimedia content displayed on the interface INT6.

According to one particular embodiment of the invention, the user interaction module IN6 is a touchscreen interface.

According to another embodiment of the invention, the user interaction module IN6 is a touchscreen interface integrated into the screen associated with the terminal 60. The screen associated with the terminal is then a touchscreen.

The terminal 60 also comprises a communication module COM6 allowing the terminal 60 to connect to a communications network and to exchange data with terminals connected to this communications network, or to establish communications with other terminals. The communication module COM6 is designed to receive a communication request coming from another terminal, to send a communication request to another terminal, to receive information representative of a multimedia content and to send such information to a remote server or to a terminal.

According to one particular embodiment of the invention, the storage module MEM6 allows at least one piece of information representative of a multimedia content to be stored. The storage module MEM6 is designed to store in memory the data from a storage space ES1 or ES2.

According to one particular embodiment of the invention, the terminal 60 is a mobile or fixed terminal, or a tablet, or a connected television, or any connected object.

1. Method for creating an interaction space shared between a first terminal (T1) and a second terminal (T2), in which, prior to establishing a communication between the first terminal and the second terminal:
a first storage space of a remote server is associated with a user of the first terminal, said first storage space comprising at least one piece of information representative of a first multimedia content when said user of the first terminal consults the first multimedia content on an interface associated with the first storage space and displayed on the first terminal,
a second storage space of a remote server is associated with a user of the second terminal, said second storage space comprising at least one piece of information representative of a second multimedia content, when said user of the second terminal consults the second multimedia content on an interface associated with the second storage space and displayed on the second terminal,
following the establishment of the communication (E_COM) between the first terminal and the second terminal, the method comprises:
a step for sending (E7) to the first terminal each piece of information representative of a multimedia content comprised in the second storage space, such that the first terminal displays (E9) said multimedia content on the interface of the first terminal,
a step for sending (E10) to the second terminal each piece of information representative of a multimedia content comprised in the first storage space, such that the second terminal displays (E12) said multimedia content on the interface of the second terminal.

2. Method for creating a shared interaction space according to claim 1, in which:
information representative of a multimedia content comprised in the first storage space of the remote server is associated with information representative of a position on the interface of the first terminal, the information representative of a position corresponding to the location where the multimedia content is displayed on the interface,
sending to the second terminal information representative of a multimedia content comprised in the first storage space furthermore comprises sending the information representative of the position of said associated multimedia content.

3. Method for creating a shared interaction space according to claim 1, comprising:
a step for receiving information coming from the first terminal representative of a new multimedia content added on the interface of the first terminal during the established communication, following a detection of a user interaction,
a step for storing said information representative in the first storage space,
a step for sending to the second terminal said information representative of said new multimedia content such that the second terminal displays said new multimedia content on the interface associated with the second terminal.

4. Method for creating a shared interaction space according to claim 2, comprising:
a step for receiving information representative of a user interaction carried out on a multimedia content displayed on the interface of the first terminal,
a step for sending to the second terminal information representative of said interaction received such that the second terminal reproduces the interaction carried out on the multimedia content on the interface of the second terminal.

5. Method for communicating between at least a first terminal (T1) and a second terminal (T2), in which, prior to establishing a communication between the first terminal and the second terminal:
a first storage space from the first terminal or from a remote server is associated to a user of the first terminal, when said user of the first terminal consults at least one multimedia content via an interface associated with said first storage space and displayed on the first terminal, one piece of information representative of said consulted multimedia content is stored in said first storage space,
a second storage space from the second terminal or from a remote server is associated to a user of the second terminal, when said user of the second terminal consults at least one multimedia content via an interface associated with said second storage space and displayed on the second terminal, one piece of information representative of said consulted multimedia content is stored in said second storage space,
the method of communication comprises:
following a step for establishing (E_COM) the communication between the first terminal and the second terminal, the following steps:
for each multimedia content displayed on the interface of the first terminal:
the second terminal receives (E10) the piece of information representative of the multimedia content comprised in the first storage space,
the second terminal obtains (E11) the multimedia content using said received piece of representative information,
the display on the interface of the second terminal is modified (E12) so as to display via the interface of the second terminal the multimedia content consulted prior to establishing the communication and the multimedia content obtained.

6. Method of communication according to claim 5, furthermore comprising:
for each piece of information representative of a multimedia content comprised in the second storage space, a step for sending said representative information to the first terminal.

7. Method of communication according to claim 5, furthermore comprising a step where the second terminal receives information representative of a display position of a multimedia content on the interface of the first terminal, such that the multimedia content is displayed on the interface of the second terminal at a position identical to said display position on the interface of the first terminal.

8. Method of communication according to claim 5, in which the addition of a new multimedia content on the interface of the first terminal during the established communication triggers:
a step where the second terminal receives information representative of said new multimedia content,
a step where the second terminal obtains the new multimedia content, using said received representative information, so as to display the new multimedia content on the interface of the second terminal.

9. Method of communication according to claim 8, in which, when the new multimedia content is added on the interface of the first terminal during the established communication, the information representative of said new multimedia content is stored in the second storage space.

10. Method of communication according to claim 5, in which the end of the communication established between the first terminal and the second terminal triggers:
a step for modification of the interface of the first terminal so as to display only the multimedia contents for which representative information is stored in the first storage space,
a step for modification of the interface of second terminal so as to display only the multimedia contents for which representative information is stored in the second storage space.

11. Method of communication according to claim 5, comprising a step for storing in a memory space associated with the second terminal a content displayed on the interface of the first terminal and for which representative information is stored in the first storage space, following the detection of a user interaction intended to select said content in order to store it permanently in a memory space associated with the second terminal.

12. Method of communication according to claim 5, in which, following a step for detecting an interaction carried out on a multimedia content displayed on the interface of the first terminal, the method comprises:
a step where the second terminal receives information representative of said interaction,
a step for modification of the display of the multimedia content on the interface of the second terminal so as to reproduce said interaction on said interface.

13. Server for creating a shared interaction space, comprising:
a storage module designed to store:
in a first storage space associated with a user of the first terminal, at least one piece of information representative of a first multimedia content, when said user of the first terminal consults said first multimedia content on an interface associated with said first storage space and displayed on the first terminal,
in a second storage space associated with a user of the second terminal, at least one piece of information representative of a second multimedia content, when said user of the second terminal consults said second multimedia content on an interface associated with said second storage space and displayed on the second terminal,
a processing module designed to detect the establishment of the communication between the first terminal and the second terminal,
a communication module activated upon a command from the processing module following the establishing of the communication between the first terminal and the second terminal, said communication module being designed to send:
to the first terminal, each piece of information representative of a multimedia content comprised in the second storage space, such that the first terminal displays said multimedia content on the interface of the first terminal,
to the second terminal, each piece of information representative of a multimedia content comprised in the first storage space, such that the second terminal displays said multimedia content on the interface of the second terminal.

14. Communication terminal comprising:
an interface suitable for displaying, prior to establishing a communication between the terminal and another terminal, at least one first multimedia content consulted by a user of the terminal, one piece of information representative of the first multimedia content consulted being stored in a first storage space associated with the user of the terminal when said user consults said first multimedia content via said interface,
a processing module designed to establish a communication with said other terminal, a user of said other terminal being associated with a second storage space comprising at least one piece of information representative of a second multimedia content when the user of the other terminal consults said second multimedia content via an interface displayed on the other terminal,
a communication module designed to:
receive each piece of information representative of a multimedia content comprised in the second storage space,
obtain, from received piece of representative information, a multimedia content corresponding to the received piece of information,
the processing module being capable of modifying the display on the interface of the terminal so as to display the first multimedia content consulted prior to establishing the communication and the multimedia content obtained.

15. Computer program comprising program code instructions for executing by a processor steps, of a method for creating a shared interaction space shared between a first terminal (T1) and a second terminal (T2), in which, prior to establishing a communication between the first terminal and the second terminal:
a first storage space of a remote server is associated with a user of the first terminal, said first storage space comprising at least one piece of information representative of a first multimedia content when said user of the first terminal consults the first multimedia content on an interface associated with the first storage space and displayed on the first terminal,
a second storage space of a remote server is associated with a user of the second terminal, said second storage space comprising at least one piece of information representative of a second multimedia content, when said user of the second terminal consults the second multimedia content on an interface associated with the second storage space and displayed on the second terminal,
following the establishment of the communication (E_COM) between the first terminal and the second terminal, the method comprises:
a step for sending (E7) to the first terminal each piece of information representative of a multimedia content comprised in the second storage space, such that the first terminal displays (E9) said multimedia content on the interface of the first terminal,
a step for sending (E10) to the second terminal each piece of information representative of a multimedia content comprised in the first storage space, such that the second terminal displays (E12) said multimedia content on the interface of the second terminal.

16. Computer program comprising program code instructions for executing by a processor, steps of a method for communicating between at least a first terminal (T1) and a second terminal (T2), in which, prior to establishing a communication between the first terminal and the second terminal:
a first storage space from the first terminal or from a remote server is associated to a user of the first terminal, when said user of the first terminal consults at least one multimedia content via an interface associated with said first storage space and displayed on the first terminal, one piece of information representative of said consulted multimedia content is stored in said first storage space,
a second storage space from the second terminal or from a remote server is associated to a user of the second terminal, when said user of the second terminal consults at least one multimedia content via an interface associated with said second storage space and displayed on the second terminal, one piece of information representative of said consulted multimedia content is stored in said second storage space,
the method of communication comprises:
following a step for establishing (E_COM) the communication between the first terminal and the second terminal, the following steps:
for each multimedia content displayed on the interface of the first terminal:
the second terminal receives (E10) the piece of information representative of the multimedia content comprised in the first storage space,
the second terminal obtains (E11) the multimedia content using said received piece of representative information,
the display on the interface of the second terminal is modified (E12) so as to display via the interface of the second terminal the multimedia content consulted prior to establishing the communication and the multimedia content obtained.
